(19) United States
(12) Patent Application Publication
(10) Pub. No.: US 2021/0327015 A1
(43) Pub. Date: Oct. 21, 2021

(54) SYSTEMS AND METHODS FOR CARPOOLING

(71) Applicant: BEIJING DIDI INFINITY TECHNOLOGY AND DEVELOPMENT CO., LTD., Beijing (CN)

(72) Inventor: Shibo YU, Beijing (CN)

(73) Assignee: BEIJING DIDI INFINITY TECHNOLOGY AND DEVELOPMENT CO., LTD., Beijing (CN)

(21) Appl. No.: 17/356,560

(22) Filed: Jun. 24, 2021

Related U.S. Application Data
(63) Continuation of application No. PCT/CN2019/130350, filed on Dec. 31, 2019.

(30) Foreign Application Priority Data
Dec. 31, 2018 (CN) 201811654235.7

(51) Int. Cl. G06Q 50/30; G06Q 50/00; G06K 19/06; G06Q 10/06; G06F 16/955; G01C 21/34

(52) U.S. Cl. CPC G06Q 50/30; G06Q 50/01; G06K 19/06037; G01C 21/3407; G06Q 10/06316; G06F 16/9558; G06K 19/06028

(57) ABSTRACT

The present disclosure relates to systems and methods for carpooling. The systems and methods may include obtaining a service request and a sharing instruction initiated by a first user. The service request may include a first departure location and a first destination. The systems and methods may also include generating an information sharing link based on the service request and the sharing instruction. The systems and methods may further include transmitting the information sharing link to one or more second users. The information sharing link may be associated with an information sharing interface. The information sharing interface may be configured to use the information sharing link and guide at least one of the one or more second users to input a second departure location and a second destination.

### CROSS-REFERENCE TO RELATED APPLICATIONS

This application is a continuation of International Application No. PCT/CN2019/130350, filed on Dec. 31, 2019, which claims priority of Chinese Application No. 201811654235.7, filed on Dec. 31, 2018, the contents of each of which are hereby incorporated by reference.

### TECHNICAL FIELD

The present disclosure generally relates to online to offline (O2O) services, and in particular, to systems and methods for carpooling by multiple users.

### BACKGROUND

Carpooling, also known as car-sharing, involves the sharing of car rides for persons having similar routes. Carpooling has been a useful way of avoiding traffic congestions, reducing fuel consumptions and carbon emissions, and saving travel cost of individual passengers. Through a carpooling service platform, passengers may initiate carpooling requests by inputting their departure locations and destinations. The carpooling service platform will determine carpoolers who share the same vehicle.

In general, prospective carpoolers are more willing to enter into a carpooling experience with people they know than strangers. Therefore, carpooling between acquaintances and friends is widely welcomed and in high demand. However, in the existing carpooling service platform, a prospective carpooler may not know other carpoolers until a carpooling order is generated. In addition, existing carpooling service platforms generally provide limited or no choice for people who know one another to generate carpool orders. Thus, it is desirable to provide systems and methods for customized carpooling by multiple users, especially for people such as acquaintances or friends.

### SUMMARY

In one aspect of the present disclosure, a method for carpooling is provided. The method may be implemented on a computing device having at least one processor, at least one computer-readable storage medium, and a communication platform connected to a network. The method may include obtaining a service request and a sharing instruction initiated by a first user. The service request may include a first departure location and a first destination. The method may also include generating an information sharing link based on the service request and the sharing instruction, and transmitting the information sharing link to one or more second users. The information sharing link may be associated with an information sharing interface. The information sharing interface may be configured to use the information sharing link and guide at least one of the one or more second users to input a second departure location and a second destination.

In some embodiments, the information sharing link may be in a form of a webpage, a QR code, a bar code, an encoding, a graphic identifier, a program, or a web link.

In some embodiments, the information sharing interface may be configured to display a travel route determined based on the first departure location and the first destination of the first user, or display the second departure location and the second destination of the at least one second user.

In some embodiments, the information sharing interface may be configured to guide the at least one of the one or more second users to input a pick-up sequence.

In some embodiments, the method further may include obtaining and displaying carpooling travel information. The carpooling travel information may include information related to the first user and the at least one second user.

In some embodiments, the carpooling travel information may include a carpooling travel route.

In another aspect of the present disclosure, a system for carpooling is provided. The system may include at least one storage device and at least one processor in communication with the at least one storage device. The at least one storage device may include a set of instructions. When executing the set of instructions, the at least one processor may be configured to cause the system to obtain a service request and a sharing instruction initiated by a first user. The service request may include a first departure location and a first destination. The at least one processor may also be configured to cause the system to generate an information sharing link based on the service request and the sharing instruction, and transmit the information sharing link to one or more second users. The information sharing link may be associated with an information sharing interface. The information sharing interface may be configured to use the information sharing link and guide at least one of the one or more second users to input a second departure location and a second destination.

In yet another aspect of the present disclosure, a system for carpooling is provided. The system may include a first obtaining module, a link generation module and a link transmission module. The first obtaining module may be configured to obtain a service request and a sharing instruction initiated by a first user. The service request may include a first departure location and a first destination. The link generation module may be configured to generate an information sharing link based on the service request and the sharing instruction. The link transmission module may be configured to transmit the information sharing link to one or more second users. The information sharing link may be associated with an information sharing interface. The information sharing interface may be configured to use the information sharing link and guide at least one of the one or more second users to input a second departure location and a second destination.

In yet another aspect of the present disclosure, a non-transitory computer-readable storage medium is provided. The non-transitory computer-readable storage medium may include at least one set of instructions. When executed by at least one processor of a computing device, the at least one set of instructions may direct the at least one processor to perform acts of: obtaining a service request and a sharing instruction initiated by a first user, wherein the service request includes a first departure location and a first destination; generating an information sharing link based on the service request and the sharing instruction; and transmitting the information sharing link to one or more second users. The information sharing link may be associated with an information sharing interface. The information sharing interface may be configured to use the information sharing link and guide at least one of the one or more second users to input a second departure location and a second destination.

In yet another aspect of the present disclosure, a method for carpooling is provided. The method may be implemented on a computing device having at least one processor, at least one computer-readable storage medium, and a communication platform connected to a network. The method may include obtaining a service request initiated by a first user. The service request may include a first departure location and a first destination of the first user. The method may also include obtaining a second departure location and a second destination of at least one second user inputted via an information sharing interface. The method may further include determining a carpooling travel route based on the first departure location and the first destination of the first user, the second departure location and the second destination of the at least one second user. The information sharing interface may be associated with an information sharing link. The information sharing link may be generated based on the service request and a first instruction of the first user and transmitted to the at least one second user.

In some embodiments, the determining a carpooling travel route may include obtaining a pick-up sequence, and determining the carpooling travel route based on the first departure location and the first destination of the first user, the second departure location and the second destination of the at least one second user, and the pick-up sequence.

In some embodiments, the determining a carpooling travel route may include obtaining a second instruction from the first user. In response to the second instruction, the method may include determining the carpooling travel route based on the first departure location and the first destination of the first user, the second departure location and the second destination of the at least one second user.

In some embodiments, the method may further include generating a first car-hailing order based on the carpooling travel route, and transmitting the first car-hailing order to at least one driver.

In some embodiments, the method may further include determining an original travel route based on the first departure location and the first destination; generating a second car-hailing order based on the original travel route; and transmitting the second car-hailing order to at least one driver.

In some embodiments, the method may further include updating the original travel route based on the second departure location and the second destination of the at least one second user, and transmitting the updated travel route to the at least one driver.

In yet another aspect of the present disclosure, a system for carpooling is provided. The system may include at least one storage device and at least one processor in communication with the at least one storage device. The at least one storage device may include a set of instructions. When executing the set of instructions, the at least one processor may be configured to cause the system to obtain a service request initiated by a first user. The service request may include a first departure location and a first destination of the first user. The at least one processor may be further configured to cause the system to obtain a second departure location and a second destination of at least one second user inputted via an information sharing interface, and determine a carpooling travel route based on the first departure location and the first destination of the first user, the second departure location and the second destination of the at least one second user. The information sharing interface may be associated with an information sharing link. The information sharing link may be generated based on the service request and a first instruction of the first user and transmitted to the at least one second user.

In yet another aspect of the present disclosure, a system for carpooling is provided. The system may include a second obtaining module, and a route determination module. The second obtaining module may be configured to obtain a service request initiated by a first user. The service request may include a first departure location and a first destination of the first user. The second obtaining module may also be configured to obtain a second departure location and a second destination of at least one second user inputted via an information sharing interface. The route determination module may be configured to determine a carpooling travel route based on the first departure location and the first destination of the first user, the second departure location and the second destination of the at least one second user. The information sharing interface may be associated with an information sharing link. The information sharing link may be generated based on the service request and a first instruction of the first user and transmitted to the at least one second user.

In yet another aspect of the present disclosure, a non-transitory computer-readable storage medium is provided. The non-transitory computer-readable storage medium may include at least one set of instructions. When executed by at least one processor of a computing device, the at least one set of instructions may direct the at least one processor to perform acts of: obtaining a service request initiated by a first user, the service request including a first departure location and a first destination of the first user; obtaining a second departure location and a second destination of at least one second user inputted via an information sharing interface; and determining a carpooling travel route based on the first departure location and the first destination of the first user, the second departure location and the second destination of the at least one second user. The information sharing interface may be associated with an information sharing link. The information sharing link may be generated based on the service request and a first instruction of the first user and transmitted to the at least one second user.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary O2O service system according to some embodiments of the present disclosure;

FIG. 2 is a schematic diagram illustrating exemplary hardware and software components of a computing device according to some embodiments of the present disclosure;

FIG. 3 is a schematic diagram illustrating exemplary hardware and/or software components of a mobile device on which a terminal may be implemented according to some embodiments of the present disclosure;

FIG. 4 is a block diagram illustrating an exemplary second processing device according to some embodiments of the present disclosure;

FIG. 5 is a block diagram illustrating an exemplary first processing device according to some embodiments of the present disclosure;

FIG. 6 is a flowchart illustrating an exemplary process for carpooling according to some embodiments of the present disclosure;

FIG. 7 is a flowchart illustrating an exemplary process for carpooling according to some embodiments of the present disclosure; and

FIG. 8 is a flowchart illustrating an exemplary process for carpooling according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Embodiments of the present disclosure may be applied to different transportation systems including but not limited to land transportation, sea transportation, air transportation, space transportation, or the like, or any combination thereof. A vehicle of the transportation systems may include a rickshaw, travel tool, taxi, chauffeured car, hitch, bus, rail transportation (e.g., a train, a bullet train, high-speed rail, and subway), ship, airplane, spaceship, hot-air balloon, driverless vehicle, or the like, or any combination thereof. The transportation system may also include any transportation system that applies management and/or distribution, for example, a system for sending and/or receiving an express.

The application scenarios of different embodiments of the present disclosure may include but not limited to one or more webpages, browser plugins and/or extensions, client terminals, custom systems, intracompany analysis systems, artificial intelligence robots, or the like, or any combination thereof. It should be understood that application scenarios of the system and method disclosed herein are only some examples or embodiments. Those having ordinary skills in the art, without further creative efforts, may apply these drawings to other application scenarios. For example, other similar server.

The term “passenger,” “requester,” “requestor,” “service requester,” “service requestor” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a requester, a passenger, a driver, an operator, or the like, or any combination thereof. In the present disclosure, “requester” and “requester terminal” may be used interchangeably, and “provider” and “provider terminal” may be used interchangeably.

The term “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

An aspect of the present disclosure relates to systems and methods for carpooling by multiple users (also referred to as carpoolers). The systems and methods may be implemented on a user terminal of a first user. The systems and methods may obtain a service request and a sharing instruction initiated by a first user. The service request may include a first departure location and a first destination. The systems and methods may generate an information sharing link based on the service request and the sharing instruction, and then transmit the information sharing link to one or more second users. The information sharing link may be associated with an information sharing interface. The information sharing interface may be configured to use the information sharing link and guide at least one of the one or more second users to input a second departure location and a second destination. In some embodiments of the present disclosure, carpooling between acquaintances and friends can be implemented, which may improve the communication efficiency and the user experience (carpooler's experience).

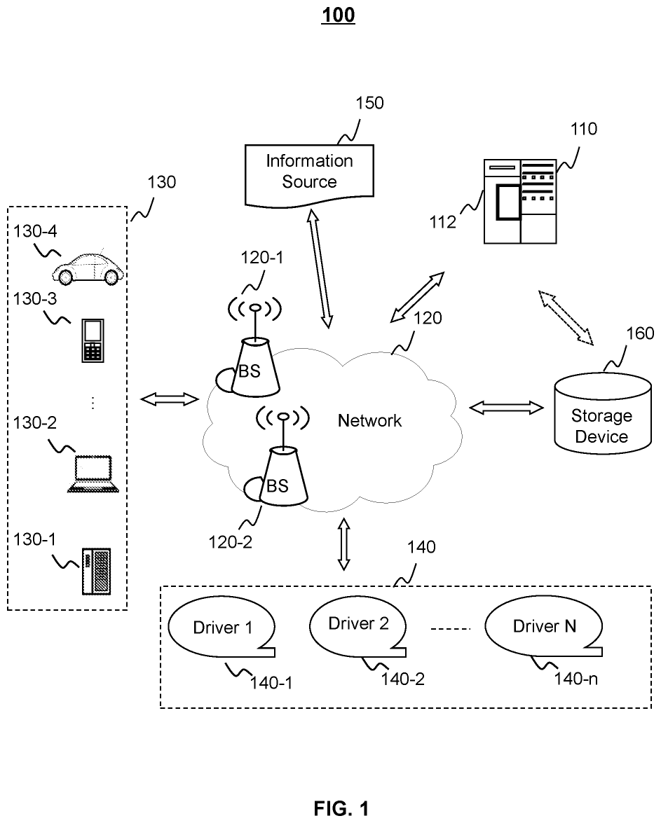

FIG. 1 is a block diagram illustrating an exemplary online to offline (O2O) service system 100 according to some embodiments of the present disclosure. For example, the O2O service system 100 may be an online transportation service platform for transportation services. The O2O service system 100 may include a server 110, a network 120, a requester terminal 130, a provider terminal 140, an information source 150, and a storage device 160.

The O2O service system 100 may provide a plurality of services. Exemplary service may include a taxi-hailing service, a carpooling service, a chauffeur service, an express car service, a bus service, a driver hire service, and a shuttle service. In some embodiments, the O2O service may be any online service, such as booking a meal, shopping, or the like, or any combination thereof.

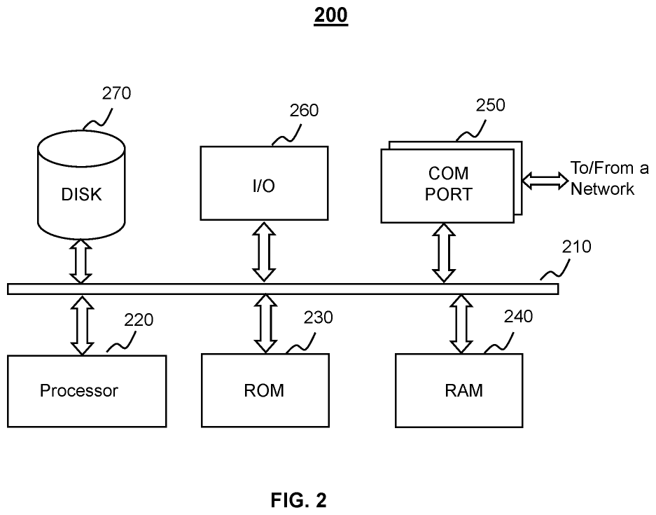

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, the information source 150, and/or the storage device 160 via the network 120. As another example, the server 110 may be directly connected to the requester terminal 130, the provider terminal 140, the information source 150, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing device 112. The processing device 112 may process information and/or data relating to lane broadcast to perform one or more functions described in the present disclosure. For example, the processing device 112 may obtain a service request initiated by a first user, and generate an original travel route based on the service request. As another example, the processing device 112 may update or adjust the original travel route based on a departure location and destination of at least one second user. In some embodiments, the processing device 112 may include one or more processing engines (e.g., single-core processing engine(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the O2O service system 100 (e.g., the server 110, the requester terminal 130, the provider terminal 140, the information source 150, and the storage device 160) may transmit information and/or data to other component(s) of the O2O service system 100 via the network 120. For example, the server 110 may receive a service request from the requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the O2O service system 100 may be connected to the network 120 to exchange data and/or information.

In some embodiments, a passenger may be an owner of the requester terminal 130. In some embodiments, the owner of the requester terminal 130 may be someone other than the passenger. For example, an owner A of the requester terminal 130 may use the requester terminal 130 to transmit a service request for a passenger B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “passenger” and “passenger terminal” may be used interchangeably, and “service provider” and “provider terminal” may be used interchangeably. In some embodiments, the provider terminal may be associated with one or more service providers (e.g., a night-shift service provider, or a day-shift service provider).

In some embodiments, the requester terminal 130 may include a tablet computer 130-1, a laptop computer 130-2, a mobile device 130-3, a built-in device in a vehicle 130-4, or the like, or any combination thereof. In some embodiments, the mobile device 130-3 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift, a HoloLens, a Gear VR, etc. In some embodiments, the built-in device in the vehicle 130-4 may include an onboard computer, an onboard television, a head up display (HUD), an on-board diagnostic (OBD) system, etc. In some embodiments, the requester terminal 130 may be a device with positioning technology for locating the position of the passenger and/or the requester terminal 130.

In some embodiments, the requester terminal 130 may include a second processing device 132. In some embodiments, the second processing device 132 may include one or more processing devices (e.g., single-core processing engine(s) or multi-core processor(s)). Merely by way of example, the second processing device 132 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof. The second processing device 132 may obtain a service request (e.g., a carpooling service request) via user input, or from one or more components of the O2O service system 100 (e.g., the server 110, the information source 150, or the storage device 160) via the network 120.

The provider terminal 140 may include a plurality of provider terminals, such as drivers 140-1, 140-2, . . . , 140-n. In some embodiments, the provider terminal 140 may be similar to, or the same device as the requester terminal 130. In some embodiments, the provider terminal 140 may be customized to implement the O2O service system 100. In some embodiments, the provider terminal 140 may be a device with positioning technology for locating the position of the service provider, the provider terminal 140, and/or a vehicle associated with the provider terminal 140. In some embodiments, the requester terminal 130 and/or the provider terminal 140 may communicate with another positioning device to determine the position of the passenger, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether a vehicle associated with the provider terminal 140 is available to carry a passenger. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the O2O transportation service 100. In some embodiments, the provider terminal 140 may correspond to one or more vehicles. The vehicles may carry the passenger and travel to the destination. In some embodiments, the vehicles may include a car, an aircraft, a space shuttle, an electric car, a hybrid vehicle, or the like, or any combination thereof.

The information source 160 may be a source configured to provide other information to the O2O service system 100. For example, the information source 160 may provide service information to the O2O service system 100, such as weather condition, traffic information, road information, information of laws and regulations, news events, life information, life guide information, or the like. The information source 160 may be implemented using a single central server, multiple servers connected by the network, or multiple personal devices. When the information source is implemented using multiple personal devices, by employing a user-generated content way, such as uploading text, voice, image and video to a cloud server, an information source may be generated by the multiple personal devices and the cloud server.

The storage device 160 may store data and/or instructions. In some embodiments, the storage device 160 may store data obtained from the requester terminal 130 and/or the provider terminal 140. In some embodiments, the storage device 160 may store data and/or instructions that the server 110 may execute or use to perform exemplary methods described in the present disclosure. In some embodiments, the storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the requester terminal 130, or the provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the requester terminal 130, the provider terminal 140). In some embodiments, the storage device 160 may be part of the server 110.

In some embodiments, one or more components of the O2O service system 100 (e.g., the server 110, the requester terminal 130, the provider terminal 140) may have permissions to access the storage device 160. In some embodiments, one or more components of the O2O service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

One of ordinary skill in the art would understand that when an element (or component) of the O2O service system 100 performs, the element may perform through electrical signals and/or electromagnetic signals. For example, when a requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 130 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

It should be noted that the above description regarding the O2O service system 100 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the O2O service system 100 may further include a navigation device (not shown in FIG. 1). The navigation device may determine information associated with an object, for example, one or more of the requester terminal 130, the provider terminal 140, etc. In some embodiments, the navigation device may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation device may include one or more satellites. The satellites may determine the information mentioned above independently or jointly. The satellite navigation device may transmit the information mentioned above to the network 120, the requester terminal 130, the provider terminal 140 via wireless connections.

FIG. 2 illustrates a schematic diagram of an exemplary computing device according to some embodiments of the present disclosure. The computing device may be a computer, such as the server 110 in FIG. 1 and/or a computer with specific functions, configured to implement any particular system according to some embodiments of the present disclosure. Computing device 200 may be configured to implement any components that perform one or more functions disclosed in the present disclosure. For example, the server 110 may be implemented in hardware devices, software programs, firmware, or any combination thereof of a computer like computing device 200. For brevity, FIG. 2 depicts only one computing device. In some embodiments, the functions of the computing device, providing function that recommending pick-up locations may require, may be implemented by a group of similar platforms in a distributed mode to disperse the processing load of the system.

Computing device 200 may include a communication port (COM PORT) 250 that may connect with a network that may implement the data communication. Computing device 200 may also include a processor 220 that is configured to execute instructions and includes one or more processors. The schematic computer platform may include an internal communication bus 210, different types of program storage units and data storage units (e.g., a hard disk 270, a read-only memory (ROM) 230, a random-access memory (RAM) 240), various data files applicable to computer processing and/or communication, and some program instructions executed possibly by the processor 220. Computing device 200 may also include an I/O device 260 that may support the input and output of data flows between computing device 200 and other components. Moreover, computing device 200 may receive programs and data via the communication network.

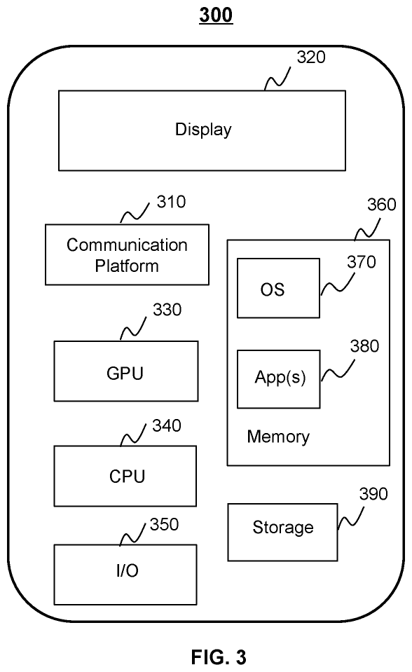

FIG. 3 is a schematic diagram illustrating exemplary hardware and/or software components of an exemplary mobile device on which a terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, a storage 390. In some embodiments, any other suitable component, including but not limited to a system bus or a controller (not shown), may also be included in the mobile device 300.

In some embodiments, a mobile operating system 370 (e.g., iOS™, Android™′ Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the O2O service system 100. User interactions with the information stream may be achieved via the I/O 350 and provided to the database 130, the server 105 and/or other components of the O2O service system 100. In some embodiments, the mobile device 300 may be an exemplary embodiment corresponding to the requester terminal 130 or the provider terminal 140.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

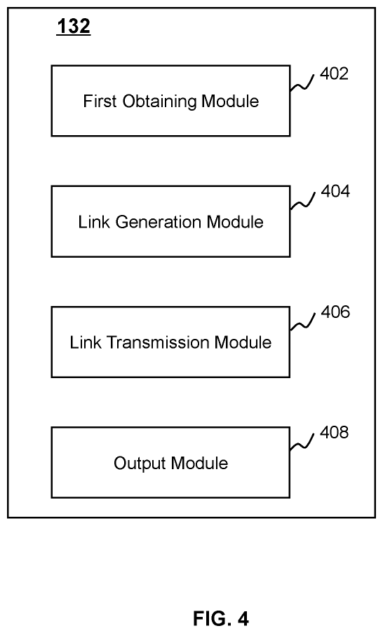

FIG. 4 is block diagram illustrating an exemplary second processing device according to some embodiments of the present disclosure. As shown in FIG. 4, the second processing device 132 may include a first obtaining module 402, a link determination module 404, a link transmission module 406, and an output module 408. In some embodiments, the second processing device 132 may be a part of the requester terminal 130. In some embodiments, the modules may be hardware circuits of all or part of the second processing device 132. The modules may also be implemented as an application or set of instructions read and executed by the second processing device 132. Further, the modules may be any combination of the hardware circuits and the application/instructions. For example, the modules may be the part of the second processing device 132 when the second processing device 132 is executing the application/set of instructions.

The first obtaining module 402 may be configured to obtain information and/or data related to a service requester. In some embodiments, the first obtaining module 402 may obtain the information and/or data related to the service requester via a user input, or from one or more components of the O2O service system 100 (e.g., the server 110, the information source 150, or the storage device 160) via the network 120.

In some embodiments, the first obtaining module 402 may obtain a service request and a sharing instruction initiated by a first user (i.e., a service requester). The first user may be one of users who want to sharing a vehicle. The first user may also be referred to as an initiator. In some embodiments, the service request may include a first departure location and a first destination. The first departure location may be a current location of the first user, which may be determined according to a GPS device installed on the requester terminal 130. Alternatively, the first departure location may be a specific location designated or inputted by the first user via the requester terminal 130. The first destination may be designated or inputted by the first user via the requester terminal 130. In some embodiments, the first departure location and/or the first destination may be represented by coordinates (e.g., latitude-longitude coordinates), or by a name of a building or a name of a street, etc.

In some embodiments, the service request may also include other information such as the total number of carpoolers, the number of passengers, a pick-up sequence, a departure time, a vehicle type, a service type, or the like. In some embodiments, “the total number of carpoolers” may refer to the number of passengers that can share the vehicle. For example, if the total number of carpoolers inputted by the first user is 3, three passengers (including the initiator) can share the same vehicle. If the first user does not input the total number of carpoolers, the total number of carpoolers may be the maximum number of passengers that a vehicle can carry. For example, for a car, the maximum number of passengers that the car can carry may be 4, and the total number of carpoolers may be 4. As used herein, “the number of passengers” may be a sum of the first user and passengers who have the same departure location and the destination and will accompany the first user. If the number of passengers inputted by the first user is 2, it may indicate that the first user will bring a companion. If the second user does not input the number of passengers, the number of passengers may be a default value (such as 1). That is, the second user will not bring a companion. The “pick-up sequence” may refer to a sequence of picking up the carpooling users. The pick-up sequence may be a sequence negotiated by all carpooling users. In some embodiments, the first user may not need to input the pick-up sequence. The departure time may include a current time, a scheduled time, or the like. For example, the first user may input a scheduled time, e.g., 10:00 am (assuming the current time is 7:00 am), via the requester terminal 130. As another example, if the first user does not input the departure time, the current time may be determined as the departure time.

In some embodiments, the sharing instruction may be an instruction for sharing the service request (or a route generated based on the service request) to other users. In some embodiments, the sharing instruction may be triggered by touching or clicking a graphical button on an interface of the requester terminal 130. In some embodiments, the first obtaining module 402 may transmit the service request and the sharing instruction to other modules of the second processing device 132 for sequence processing. For example, the first obtaining module 402 may transmit the service request and the sharing instruction to the link generation module 404 for generating an information sharing link.

In some embodiments, the link generation module 404 may be configured to generate an information sharing link. In some embodiments, the link generation module 404 may generate the information sharing link based on the service request and the sharing instruction. As described above, the sharing instruction may be generated when the first user touches or clicks the graphical button, and may be transmitted to the link generation module 404. The link generation module 404 may generate the information sharing link based on the service request in response to the sharing instruction. The information sharing link may be in a form of a webpage, a QR code, a bar code, an encoding, a graphic identifier, a program, a web link, or the like, or any combination thereof.

In some embodiments, the information sharing link may be transmitted to one or more second users (e.g., by the link transmission module 406). The one or more second user may include carpooling users other than the initiator. When a second user receives the information sharing link, the second user can further share the information sharing link to other users. For example, user A, who is an initiator, may share the information sharing link to user B. User A or user B can further share the information sharing link to other users, e.g., user C, user D, etc. In some embodiments, the information sharing link may be associated with an information sharing interface. A second user may display the information sharing interface on his or her requester terminal by triggering (e.g., clicking) the information sharing link.

The information sharing interface may be configured to use the information sharing link and guide at least one of the one or more second users to input a second departure location and a second destination. In some embodiments, the second departure location may be the same as the first departure location. For example, two users (e.g., friends) may need to go back to their own homes after dinner. In this case, the departure locations of the two users may be the same (e.g., a restaurant), while the destinations of the two users may be different. In some embodiments, the second destination may be the same as the first destination. For example, two users (e.g., colleagues) who don't live together may need to go to the same destination (e.g., the company). In this case, the departure locations of the two users may be different, while the destinations of the two users may be the same. In some embodiments, the second departure location may be different from the first departure location, and the second destination may be different from the first destination.

In some embodiments, the information sharing interface may also be used to guide the at least one second user to input the number of passengers, a pick-up sequence, or the like. As used herein, “the number of passengers” inputted by a second user may be a sum of the second user and passengers accompanying the second user. In some embodiments, a second user may carry a companion or child having the same departure location and destination as him or her. In some embodiments, a second user may input the number of passengers on the information sharing interface. For example, if a second user wants to bring a companion, the second user may input the number of passengers on the information sharing interface as 2. In some embodiments, if a second user does not input the number of passengers on the information sharing interface, the number of passengers may be the default value, such as 1. It should be noted that the number of passengers inputted by the second user should be less than the total number of carpoolers inputted by the first user. For example, if the total number of carpoolers is four, the number of passengers inputted by the second user may be 1, 2, 3. As described above, the pick-up sequence may refer to a sequence of picking up the carpooling users. In some embodiments, the pick-up sequence may be a sequence negotiated by the carpooling users (including the first user and the second user(s)), and may be inputted by the first user. In some embodiments, if the first user does not input the pick-up sequence, the second user(s) can input his desired pick-up sequence. If two second users select the same pick-up sequence, the server 110 may send a warning to the two second users. The two second users may negotiate and adjust the pick-up sequence. In some embodiments, if all the carpooling users (including the first user and the second user(s)) do not input the pick-up sequence, the server 110 may determine a carpooling travel route (e.g., an optimal travel route) based on the first departure location and the first destination of the first user, the second departure location(s) and the second destination(s) of the second user(s). The server 110 may determine the pick-up sequence based on the carpooling travel route. Alternatively, if all the carpooling users (including the first user and the second user(s)) do not input the pick-up sequence, the server 110 may determine the pick-up sequence based on a sequence that the second users input the information (e.g., the second departure location, the second destination).

In some embodiments, the information sharing interface may be configured to display a travel route determined based on the first departure location and the first destination of the first user. The information sharing interface may also be configured to display the second departure location and the second destination of the at least one second user. In some embodiments, the information sharing interface may be configured to guide a second user to input information (e.g., the second departure location, the second destination, the number of passengers, the pick-up sequence). Additionally, the information sharing interface may also be configured to guide the second user to submit the information (e.g., the second departure location, the second destination, the number of passengers, the pick-up sequence) to the O2O service system 100 (e.g., the server 110). For example, when a second user completes the information input, the information sharing interface may guide the user to submit the information to the server 110. In some embodiments, if a second user does not want to participate in the carpooling service, the second user can close the information sharing interface.

The link transmission module 406 may be configured to transmit the information sharing link to one or more second users. In some embodiments, the link transmission module 406 may transmit the information sharing link to an instant messaging software of a second user. The instant messaging software may be installed in a requester terminal (e.g., the requester terminal 130) of the second user and capable of real-time communication with the corresponding instant messaging software installed in the requester terminal of the first user. In some embodiments, the instant messaging software may include but is not limited to microblog, WeChat, QQ, MSN, Ding Talk, skype, a browser (e.g., a UC browser, a Baidu browser, a Google browser), or the like, or any combination thereof. In some embodiments, the first user may select an instant messaging software (e.g., WeChat) by clicking the instant messaging software, and select the one or more second users via the instant messaging software. The link transmission module 406 may transmit the information sharing link to the corresponding instant messaging software of the one or more second users.

In some embodiments, the information sharing link may be shared and/or transmitted in the instant messaging software via a form of a webpage, a QR code, a bar code, an encoding, a graphic identifier, a program, a web link, or the like, or any combination thereof. For example, the information sharing link may be transmitted as a QR code. The link transmission module 406 may transmit the QR code to the corresponding instant messaging software of the one or more second users. The information sharing interface may be triggered by identifying the QR code via the operation of the one or more second users. In some embodiments, the information sharing link may be shared or transmitted in the O2O service system 100. For example, the link transmission module 406 may transmit the information sharing link to the O2O service system 100 of the one or more second users. The information sharing interface may be displayed on the O2O service system 100 of the one or more second users by clicking the information sharing link.

The output module 408 may be configured to obtain and display carpooling travel information. In some embodiments, the carpooling travel information may include information related to the first user and at least one second user, such as the first departure location and the first destination of the first user, the second departure location and the second destination of the at least one second user, the name (or nickname) of each user, the profile photo of each user, the real-time location of each user, or the like, or any combination thereof. In some embodiments, the carpooling travel information may also include a carpooling travel route, the total number of carpoolers, the pick-up sequence, an estimated pick-up time of each user, an estimated arrival time of each user, or the like. In some embodiments, the carpooling travel route may be an optimal travel route determined based on the first departure location and the first destination of the first user, the second departure location and the second destination of the at least one second user, and/or the pick-up sequence. In some embodiments, the estimated pick-up time or the estimated arrival time may be determined based on the departure location and the destination of each user, traffic conditions, weather conditions, or the like.

In some embodiments, for illustration purposes, the present disclosure describes the process of carpooling by four users. For example, users A′, B′, C′ and D′ agree to carpooling. User A′ may initiate a service request via the requester terminal 130. In some embodiments, user A′ may input, via the requester terminal 130, a first departure location, a first destination, a departure time, the total number of carpoolers, a pick-up sequence, or the like, or any combination thereof. After user A′ finishes the input, user A′ may click or touch a graphical button to trigger a sharing instruction. An information sharing link may be generated based on the service request and the sharing instruction. User A′ may select an instant messaging software (e.g., WeChat) and select users (e.g., users B′, C′ and D′) to share the information sharing link. The information sharing link may be transmitted to the corresponding instant messaging software (e.g., WeChat) of the selected users (i.e., users B′, C′ and D′, also referred to as second users). The selected users (i.e., users B′, C′, and D′) may trigger an information sharing interface by the information sharing link. In some embodiments, the information sharing interface may be configured to display the service request inputted by user A′, a travel route determined based on the first departure location and the first destination. The information sharing interface may guide at least one of the selected users to input information such as a second departure location, a second destination, a pick-up sequence, etc. The information sharing interface may also guide the selected users to submit the inputted information to the O2O service system 100 (e.g., the server 110). When the server 110 receives the information inputted by the users A′, B′, C′ and D′, the server 110 may generate a carpooling travel route based on the information inputted by the users A′, B′, C′ and D′, and generate a car-hailing order based on the carpooling travel route. In some embodiments, the information sharing interface may display the carpooling travel route, the pick-up sequence, the total number of carpoolers, the departure location and destination of each user. In some embodiments, when the car-hailing order is accepted by a service provider (e.g., a driver), the information sharing interface may display the basic information of the driver (e.g., the name of the driver, the license plate number of the driver, the contact information of the driver), the current location of the driver, the real-time driving route, etc. When users A′, B′, C′, and D′ reach their destinations (i.e., the car-hailing order is completed), the information sharing interface may be automatically closed.

It should be noted that the above descriptions of the second processing device 132 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the first obtaining module 402 may be divided into two units. A first unit may be configured to obtain the service request of the first user. A second unit may be configured to obtain the sharing instruction. In some embodiments, the second processing device 132 may include one or more additional modules. For example, the second processing device 132 may include a storage module (not shown). The storage module may be configured to store data generated during any process performed by any component of the second processing device 132.

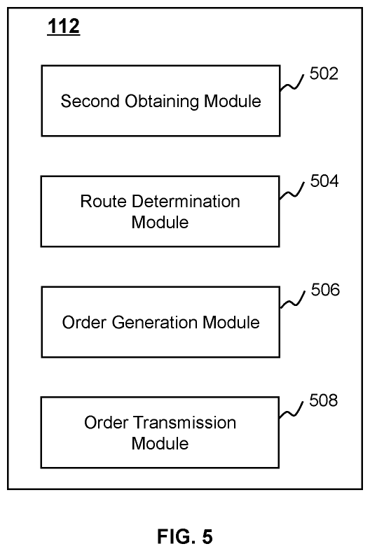

FIG. 5 is block diagram illustrating an exemplary first processing device according to some embodiments of the present disclosure. As shown in FIG. 5, the first processing device 112 may include a second obtaining module 502, a route determination module 504, an order generation module 506, and an order transmission module 508. In some embodiments, the first processing device 112 may be a part of the server 110. In some embodiments, the modules may be hardware circuits of all or part of the first processing device 112. The modules may also be implemented as an application or set of instructions read and executed by the first processing device 112. Further, the modules may be any combination of the hardware circuits and the application/instructions. For example, the modules may be the part of the first processing device 112 when the first processing device 112 is executing the application/set of instructions.

The second obtaining module 502 may be configured to obtain information and/or data related to the O2O service system 100. In some embodiments, the processing device 112 may obtain the information and/or data from one or more components of the O2O service system 100 (e.g., the requester terminal 130, the provider terminal 140, the storage device 160), or from an external source via the network 120.

In some embodiments, the second obtaining module 502 may obtain a service request initiated by a first user. The first user may also be referred to as an initiator. The service request may include a first departure location and a first destination of the first user. In some embodiments, the service request may also include the total number of carpoolers, a pick-up sequence, a departure time, a vehicle type, a service type, or the like. In some embodiments, the second obtaining module 502 may also obtain information inputted by at least one second user. The second user(s) may refer to carpooling users other than the initiator. For example, the second obtaining module 502 may obtain a second departure location and a second destination of the at least one second user inputted via an information sharing interface. As another example, the second obtaining module 502 may obtain the number of passengers, a pick-up sequence, etc. inputted by the at least one second user via the information sharing interface. In some embodiments, the information sharing interface may be associated with an information sharing link. The information sharing link may be generated based on the service request and a sharing instruction (also referred to as a first instruction) of the first user and transmitted to the at least one second user. In some embodiments, the information sharing link may be shared and/or transmitted in an instant messaging software (such as WeChat, microblog, QQ, etc.), or in the O2O service system 100. More descriptions regarding the information sharing link and the information sharing interface may be found elsewhere in the present disclosure (e.g., FIG. 4 and the relevant descriptions thereof).

The route determination module 504 may be configured to determine a carpooling travel route. In some embodiments, the route determination module 504 may determine the carpooling travel route based on the first departure location and the first destination of the first user, the second departure location and the second destination of the at least one second user. In some embodiments, the carpooling travel route may be the shortest travel route, among all travel routes passing the departure location and the destination of each user (including the first user and the second user(s)), or the least time-consuming travel route among all travel routes passing the departure location and the destination of each user (including the first user and the second user(s)), or the least cost travel route among all travel routes passing the departure location and the destination of each user (including the first user and the second user(s)). In some embodiments, the route determination module 504 may obtain a pick-up sequence inputted by the first user or the second user(s). The route determination module 504 may determine the carpooling travel route based on the first departure location and the first destination of the first user, the second departure location and the second destination of the at least one second user, and the pick-up sequence. In some embodiments, the carpooling travel route may be displayed on the information sharing interface. If the first user or the second user(s) finds that the carpooling travel route is detoured, he or her can adjust the pick-up sequence. The route determination module 504 may adjust the carpooling travel route based on the adjusted pick-up sequence.

In some embodiments, the route determination module 504 may obtain a second instruction (also referred to as a carpooling instruction) from the first user (i.e., the initiator). In some embodiments, the second instruction may be an instruction that all users have completed the information input via the information sharing interface. In response to the second instruction, the route determination module 504 may determine the carpooling travel route based on the first departure location and the first destination of the first user, the second departure location and the second destination of the at least one second user. In some embodiments, the route determination module 504 may obtain the second instruction from the at least one second user, and determined the carpooling travel route in response to the second instruction. In some embodiments, the second instruction may be automatically generated when all users have completed the information input. For example, a first user initiates a service request and shares the service request (via an information sharing link) to three second users. When the route determination module 504 receives information inputted by three second users via the information sharing interface, the route determination module 504 may determine that all users have completed the information input, and automatically generate the second instruction. As another example, a first user may input the total number of carpoolers. The route determination module 504 may count the number of passengers inputted by the second users that have completed the information input. When a sum of passengers inputted by the second users and the first user is equal to the total number of carpoolers, the route determination module 504 may generate the second instruction automatically.

In some embodiments, all second users may need to submit his or her own second instruction. For example, when a second user completes the information input, the second user may need to submit a second instruction to the server 110. The route determination module 504 may determine whether the number of second instructions is equal to or greater than a threshold. If the number of second instructions is equal to or greater than the threshold, the route determination module 504 may determine that all users have submitted the second instruction, and may start to determine the carpooling travel route based on the first departure location and the first destination of the first user, the second departure location and the second destination of each second user. The threshold may be related to the total number of carpoolers inputted by the first user. Assuming none of the second users is allowed to bring a companion, the threshold may be the total number of carpoolers other than the first user. Merely by way of example, a first user (e.g., Li) initiates a service request and shares the service request (via an information sharing link) to two second users (e.g., Wang, Zhang). The total number of carpoolers inputted by the first user (i.e., Li) is 3. When the route determination module 504 determines the number of second instructions may be 2 (which is equal to the total number of carpoolers other than the initiator, i.e., 3-1), the route determination module 504 may determine that the two second users have completed the information input and submitted the second instructions to the server 110. The route determination module 504 may then determine the carpooling travel route based on the first departure location and first destination of the first user, and the second departure location and the second destination of the two second users. If only one second user (e.g., Wang) submits the second instruction, the route determination module 504 may not generate the carpooling travel route. In some embodiments, the route determination module 504 may remind other second user (e.g., Zhang) to complete the information input and submit the second instruction by sending a prompting message. When the two second users have submitted the second instructions, the route determination module 504 may then determine the carpooling travel route.

In some embodiments, the route determination module 504 may determine an original travel route based on the first departure location and the first destination. The original travel route may be a travel route generated based on the service request of the first user (i.e., the initiator). In some embodiments, the route determination module 504 may update and/or modify the original travel route based on the second departure location and the second destination of the at least one second user. By updating or modifying the original travel route, a carpooling travel route passing the departure location and destination of each user (including the first user, the second user(s)) may be determined. For example, a first user (e.g., Li) initiates a service request and share the service request to three second users (e.g., Wang, Zhang, Liu). The route determination module 504 may determine an original travel route based on the service request initiated by the first user. When a second user (e.g., Wang) completes the information input, the route determination module 504 may update or modify the original travel route based on information inputted by the second user (i.e., Wang) via the information sharing interface. When other second users (e.g., Zhang, Liu) completes the information input, the route determination module 504 may further update or modify the original travel route based on the information inputted by the second users (i.e., Zhang, Liu) via the information sharing interface.

The order generation module 506 may be configured to generate a car-hailing order (also referred to as a first car-hailing order) based on the carpooling travel route. In some embodiments, the car-hailing order may include may include carpooling travel information. The carpooling travel information may include information related to the first user and the second user(s), such as the first departure location and the first destination of the first user, the second departure location and the second destination of the at least one second user, the name (or nickname) of each user, the profile photo of each user, the real-time location of each user, or the like. In some embodiments, the carpooling travel information may also include a carpooling travel route, the total number of carpoolers, the pick-up sequence, an estimated pick-up time of each user, an estimated arrival time of each user, or the like. In some embodiments, the order generation module 506 may generate a car-hailing order (also referred to as a second car-hailing order) based on the original travel route.

The order transmission module 508 may be configured to transmit the car-hailing order to at least one driver (e.g., the provider terminal 140 of the at least one driver). In some embodiments, the order transmission module 508 may determine at least one driver based on the information inputted by the first user (e.g., a departure time, a desired vehicle type, a desired service type) and the carpooling travel route. The order transmission module 508 may transmit the car-hailing order to the at least one driver. A driver who first clicks the “accept” button may obtain the car-hailing order. Alternatively, the order transmission module 508 may transmit the car-hailing order to one driver who has the highest score among the at least one driver. In some embodiments, the car-hailing order may be a first car-hailing order generated based on the carpooling travel route. In some embodiments, the car-hailing order may be a second car-hailing order generated based on the original travel route. When the second car-hailing order is accepted by the driver, the server 110 (e.g., the route determination module 504) may continue to receive second departure location and second destination inputted by the second user(s), and update the original travel route based on the received second departure location and second destination of the second user(s). The order transmission module 508 may transmit the updated travel route to the driver to optimize the driving route of the driver.

It should be noted that the above descriptions of the first processing device 112 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the order generation module 506 and the order transmission module 508 may be integrated into one module, configured to generate the car-hailing order and transmit the car-hailing order to at least one driver. In some embodiments, the first processing device 112 may include one or more additional modules. For example, the first processing device 112 may include a storage module (not shown). The storage module may be configured to store data generated during any process performed by any component of the first processing device 112.

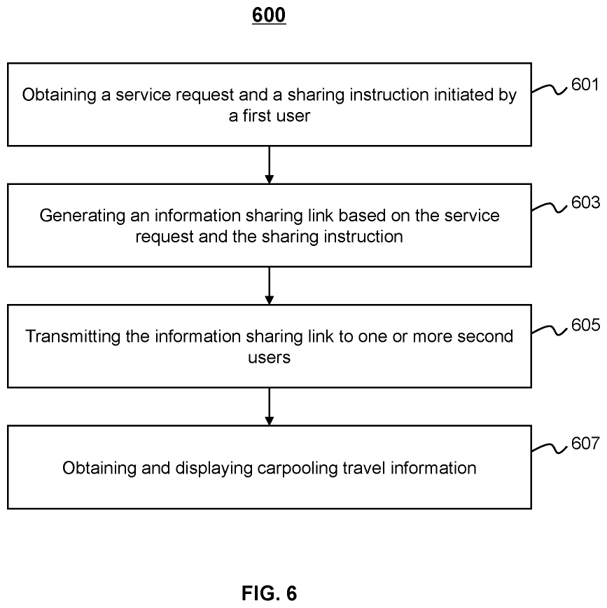

FIG. 6 is a flowchart illustrating an exemplary process for carpooling according to some embodiments of the present disclosure. For illustration purposes only, the second processing device 132 may be described as a subject to perform the process 600. However, one of ordinary skill in the art would understand that the process 600 may also be performed by other entities. For example, one of ordinary skill in the art would understand that at least a portion of the process 600 may be implemented on the computing device 200 as illustrated in FIG. 2 or the mobile device 300 as illustrated in FIG. 3. In some embodiments, one or more operations of process 600 may be implemented on the O2O service system 100 as illustrated in FIG. 1. In some embodiments, one or more operations in the process 600 may be stored in the storage device 150 and/or the storage (e.g., the ROM 230, the RAM 240, etc.) as a form of instructions, and invoked and/or executed by the requester terminal 130 (e.g., the second processing device 132 in the requester terminal 130). In some embodiments, the instructions may be transmitted in a form of electronic current or electrical signals.

In 601, the second processing device 132 (e.g., the first obtaining module 402) may obtain a service request and a sharing instruction initiated by a first user (also referred to as an initiator). In some embodiments, the first user may input the service request and the sharing instruction via a user terminal (e.g., the requester terminal 130) of the first user. The service request may include a first departure location and a first destination. The first departure location may be the current location of the first user, or a specific location inputted by the first user. The first destination may be designated or inputted by the first user. In some embodiments, the first departure location and/or the first destination may be represented by coordinates (e.g., latitude-longitude coordinates), or by a name of a building or a name of a street, etc. In some embodiments, the service request may also include other information such as the total number of carpoolers, a pick-up sequence, a departure time, a vehicle type, a service type, or the like, or any combination thereof. In some embodiments, the sharing instruction may be an instruction for sharing the service request (or a route generated based on the service request) to other users. In some embodiments, the sharing instruction may be triggered by touching or clicking a graphical button on an interface of the requester terminal 130. Details regarding the service request and the sharing instruction may be found elsewhere in the present disclosure (e.g., FIG. 4 and the relevant descriptions thereof).

In 603, the second processing device 132 (e.g., the link generation module 404) may generate an information sharing link based on the service request and the sharing instruction. In some embodiments, the information sharing link may be in a form of a webpage, a QR code, a bar code, an encoding, a graphic identifier, a program, a web link, or the like, or any combination thereof.

In 605, the second processing device 132 (e.g., the link transmission module 406) may transmit the information sharing link to one or more second users. The second user(s) may be carpooling users other than the initiator. In some embodiments, the second processing device 132 may transmit the information sharing link to an instant messaging software of a second user. The instant messaging software may be installed in a requester terminal (e.g., the requester terminal 130) of the second user and capable of real-time communication with the corresponding instant messaging software installed in the requester terminal of the first user. In some embodiments, the instant messaging software may include but is not limited to microblog, WeChat, QQ, MSN, Ding Talk, skype, a browser (e.g., a UC browser, a Baidu browser, a Google browser), or the like, or any combination thereof.

In some embodiments, the information sharing link may be shared and/or transmitted in the instant messaging software via a form of a webpage, a QR code, a bar code, an encoding, a graphic identifier, a program, a web link, or the like, or any combination thereof. Alternatively, the information sharing link may be shared and/or transmitted in the O2O service system 100. In some embodiments, the information sharing link may be associated with an information sharing interface. The information sharing interface may be configured to use the information sharing link and guide at least one of the one or more second users to input a second departure location and a second destination. In some embodiments, the information sharing interface may also be used to guide the at least one second user to input the number of passengers, a pick-up sequence, or the like. In some embodiments, the information sharing interface may be configured to display a travel route determined based on the first departure location and the first destination. The information sharing interface may also be configured to display the second departure location and the second destination of the at least one second user. More description of the information sharing link and/or the information sharing interface may be found elsewhere in the present disclosure (e.g., FIG. 4 and the relevant descriptions thereof).

In 607, the second processing device 132 (e.g., the output module 408) may obtain and display carpooling travel information. The second processing device 132 may display the carpooling travel information on an interface of the requester terminal 130. In some embodiments, the carpooling travel information may include information related to the first user and at least one second user, such as the first departure location and the first destination of the first user, the second departure location and the second destination of the at least one second user, the name (or nickname) of each user, the profile photo of each user, the real-time location of each user, or the like. In some embodiments, the carpooling travel information may also include a carpooling travel route, the total number of carpoolers, the pick-up sequence, an estimated pick-up time of each user, an estimated arrival time of each user, or the like.

It should be noted that the above description regarding the process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more other optional operations (e.g., a storing operation) may be added elsewhere in the process 600. In the storing operation, the second processing device 132 may store information and/or data (e.g., the service request, the information sharing link, the information inputted by the second user(s)) associated with carpooling in a storage device (e.g., the storage device 160) disclosed elsewhere in the present disclosure.

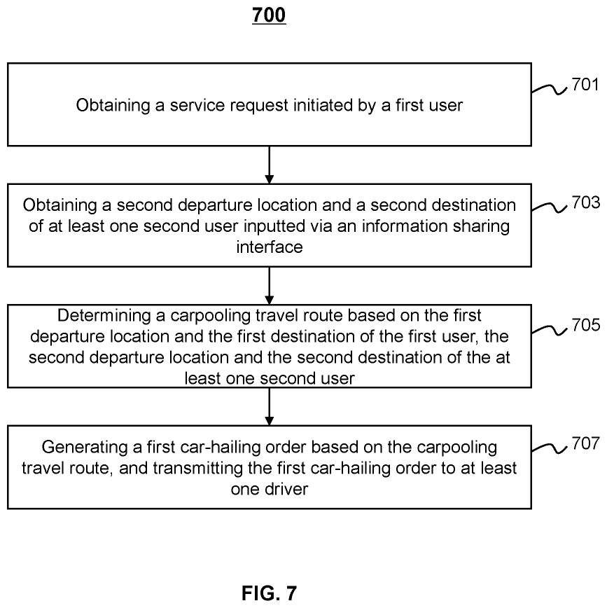

FIG. 7 is a flowchart illustrating an exemplary process for carpooling according to some embodiments of the present disclosure. For illustration purposes only, the first processing device 112 may be described as a subject to perform the process 700.

However, one of ordinary skill in the art would understand that the process 700 may also be performed by other entities. For example, one of ordinary skill in the art would understand that at least a portion of the process 700 may be implemented on the computing device 200 as illustrated in FIG. 2 or the mobile device 300 as illustrated in FIG. 3. In some embodiments, one or more operations of process 700 may be implemented on the O2O service system 100 as illustrated in FIG. 1. In some embodiments, one or more operations in the process 700 may be stored in the storage device 150 and/or the storage (e.g., the ROM 230, the RAM 240, etc.) as a form of instructions, and invoked and/or executed by the server 110 (e.g., the first processing device 112 in the server 110, or the processor 220 of the first processing device 112 in the server 110). In some embodiments, the instructions may be transmitted in a form of electronic current or electrical signals.

In 701, the first processing device 112 (e.g., the second obtaining module 502) may obtain a service request initiated by a first user (e.g., an initiator). The service request may include a first departure location and a first destination. The first departure location may be the current location of the first user, or a specific location inputted by the first user. The first destination may be designated or inputted by the first user. In some embodiments, the first departure location and/or the first destination may be represented by coordinates (e.g., latitude-longitude coordinates), or by a name of a building or a name of a street, etc. In some embodiments, the service request may also include other information such as the total number of carpoolers, a pick-up sequence, a departure time, a vehicle type, a service type, or the like, or any combination thereof. Details regarding the service request may be found elsewhere in the present disclosure (e.g., FIG. 4 and the relevant descriptions thereof).

In some embodiments, the first processing device 112 may obtain the service request from one or more components of the O2O service system 100 (e.g., the requester terminal 130, the storage 160), or from an external source via the network 120. For example, the first processing device 112 may obtain the service request from the requester terminal 130 of the first user.

In 703, the first processing device 112 (e.g., the second obtaining module 502) obtain a second departure location and a second destination of at least one second user inputted via an information sharing interface. The second user(s) may include carpooling users other than the initiator. In some embodiments, the first processing device 112 may also obtain the number of passengers, a pick-up sequence, etc. inputted by the at least one user via the information sharing interface. The information sharing interface may be associated with an information sharing link. The information sharing link may be generated based on the service request and a sharing instruction (also referred to as a first instruction) of the first user and transmitted to the at least one user. The sharing instruction may be an instruction for sharing the service request to other users (e.g., the at least one second user). The information sharing link may be shared and/or transmitted in an instant messaging software (e.g., WeChat, microblog, QQ), or in the O2O service system 100. More description regarding the information sharing link may be found elsewhere in the present disclosure (e.g., FIG. 4 and the relevant descriptions thereof).

In 705, the first processing device 112 (e.g., the route determination module 504) may determine a carpooling travel route based on the first departure location and the first destination of the first user, the second departure location and the second destination of the at least one second user. The carpooling travel route may be a travel route passing the departure location and the destination of each user (including the first user and the at least one second user). In some embodiments, the first processing device 112 may obtain the pick-up sequence, and determine the carpooling travel route based on the first departure location and the first destination of the first user, the second departure location and the second destination of the at least one second user, and the pick-up sequence. In some embodiments, the first processing device 112 may obtain a second instruction (also referred to as a carpooling instruction) from the first user. In response to the second instruction, the first processing device 112 may determine the carpooling travel route based on the first departure location and the first destination of the first user, the second departure location and the second destination of the at least one second user. More descriptions regarding the determination of the carpooling travel route may be found elsewhere in the present disclosure (e.g., FIG. 5 and the relevant descriptions thereof).

In 707, the first processing device 112 (e.g., the order generation module 506) may generate a first car-hailing order based on the carpooling travel route. In some embodiments, the first car-hailing order may include carpooling travel information. The carpooling travel information may include information related to the first user and the second user(s), such as the first departure location and the first destination of the first user, the second departure location and the second destination of the at least one second user, the name (or nickname) of each user, the profile photo of each user, the real-time location of each user, or the like. In some embodiments, the carpooling travel information may also include a carpooling travel route, the total number of carpoolers, the pick-up sequence, an estimated pick-up time of each user, an estimated arrival time of each user, or the like. The first processing device 112 (e.g., the order transmission module 508) may then transmit the first car-hailing order to at least one driver. In some embodiments, the first processing device 112 may determine at least one driver based on the information inputted by the first user and the carpooling travel route. The first processing device 112 may then transmit the car-hailing order to the at least one driver.

It should be noted that the above description regarding the process 700 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the first user can cancel the car-hailing order, while the second user(s) cannot cancel the car-hailing order. For example, if the first user wants to change his travel plan, the first user can cancel the car-hailing order. At the same time, if other users (i.e., the second users) wish to continue the travel plan, one of the second users may need to reinitiate a service request. As another example, if a second user does not want to participate in the carpooling service, the second user can close the information sharing interface, while the car-hailing order will not be cancelled.

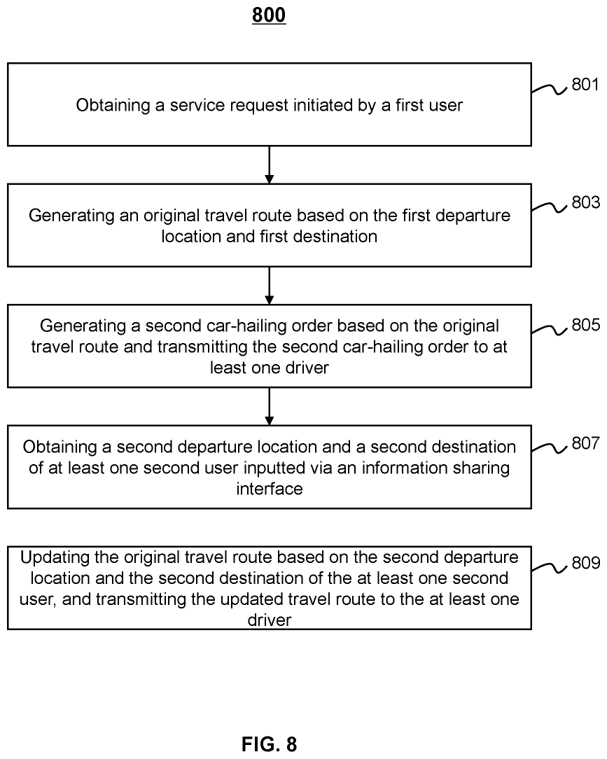

FIG. 8 is flowchart illustrating an exemplary process for carpooling according to some embodiments of the present disclosure. For illustration purposes only, the first processing device 112 may be described as a subject to perform the process 800. However, one of ordinary skill in the art would understand that the process 800 may also be performed by other entities. For example, one of ordinary skill in the art would understand that at least a portion of the process 800 may be implemented on the computing device 200 as illustrated in FIG. 2 or the mobile device 300 as illustrated in FIG. 3. In some embodiments, one or more operations of process 800 may be implemented on the O2O service system 100 as illustrated in FIG. 1. In some embodiments, one or more operations in the process 800 may be stored in the storage device 150 and/or the storage (e.g., the ROM 230, the RAM 240, etc.) as a form of instructions, and invoked and/or executed by the server 110 (e.g., the first processing device 112 in the server 110, or the processor 220 of the first processing device 112 in the server 110). In some embodiments, the instructions may be transmitted in a form of electronic current or electrical signals.

In 801, the first processing device 112 (e.g., the second obtaining module 502) may obtain a service request initiated by a first user. The service request may include a first departure location and a first destination. In some embodiments, the service request may also include other information such as the total number of carpoolers, a pick-up sequence, a departure time, a vehicle type, a service type, or the like, or any combination thereof. Operation 801 may be performed in a similar manner with operation 701, and the descriptions thereof are not repeated here.

In 803, the first processing device 112 (e.g., the route determination module 504) may determine an original travel route based on the first departure location and the destination. The original travel route may be a travel route generated based on the service request of the first user.

In 805, the first processing device 112 (e.g., the order generation module 506) may generate a second car-hailing order based on the original travel route. In some embodiments, the second car-hailing order may include carpooling travel information. The carpooling travel information may include information related to the first user, such as the first departure location and the first destination of the first user, the name (or nickname) of the first user, the profile photo of the first user, the real-time location of the first user, or the like. In some embodiments, the carpooling travel information may also include a carpooling travel route. The first processing device 112 (e.g., the order transmission module 508) may transmit the second car-hailing order to at least one driver. In some embodiments, the first processing device 112 may determine at least one driver based on the information inputted by the first user (e.g., a departure time, a vehicle type, a service type) and the original travel route. The first processing device 112 (e.g., the order transmission module 508) may then transmit the second car-hailing order to the at least one driver.

In 807, the first processing device 112 (e.g., the second obtaining module 502) may obtain a second departure location and a second destination of at least one second user inputted via an information sharing interface. In some embodiments, the first processing device 112 may also obtain the number of passengers, a pick-up sequence, etc. inputted by the at least one second user via the information sharing interface. In some embodiments, when the second car-hailing order is accepted by the driver, the first processing device 112 may continue to obtain the second departure location and the second destination of the at least one second user inputted via the information sharing interface. For example, the first processing device 112 may obtain the second departure location, the second destination, the number of passengers, or the pick-up sequence of a new second user (e.g., second user 1). In some embodiments, a second user (e.g., second user 2) may update the second departure location, the second destination, the number of passengers, or the pick-up sequence. The first processing device 112 may obtain the updated second departure location, the updated second destination, the updated number of passengers, or the updated pick-up sequence. In some embodiments, a second user (e.g., second user 3) may not want to participate in the carpooling service, and may close the information sharing interface. The first processing device 112 may delete the information (e.g., the second departure location, the second destination, the number of passengers, or the pick-up sequence) inputted by the second user (second user C).

In 809, the first processing device 112 (e.g., the route determination module 504) may update the original travel route based on the second departure location and the second destination of the at least one second user. In some embodiments, the first processing device 112 may update the original travel route based on the information inputted by a new second user (e.g., the second user 1). In some embodiments, the first processing device 112 may update the original travel route based on the updated information of a second user (e.g., the second user 2). In some embodiments, the first processing device 112 may update the original travel route when a second user (e.g., the second user 3) exit from the carpooling service. The first processing device 112 (e.g., the order transmission module 508) may transmit the updated travel route to the driver. The driver may adjust his driving route based on the updated travel route.

In some embodiments of the present disclosure, a second car-hailing order may be quickly generated based on the service request of the first user, and may be distributed to at least one driver. When a driver accepts the second car-hailing order, the first processing device 112 may continue to obtain the information inputted by the second user(s), and update the original travel route based on the information inputted by the second user(s), implementing the dynamically updating of the carpooling travel route.

It should be noted that the above description regarding the process 800 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the updated travel route, the departure location and the destination of each user (also referred to as waypoints) may be displayed on the provider terminal 140 of the driver. If the driver does not want to go to a waypoint (a departure location or destination inputted by a second user), the driver may delete the waypoint. The second user may need to modify the waypoint (i.e., the departure location or destination). Otherwise, the second user may not be picked up by the driver.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

### STATEMENT OF INVENTION

1. A carpooling method, comprising:

obtaining a service request and a sharing instruction initiated by at least one first user, wherein the service request includes a first departure location and a first destination; and

generating an information sharing link based on the service request and the sharing instruction, wherein the information sharing link is associated with an information sharing interface, and the information sharing interface is configured to guide at least one second user to input a second departure location and a second destination.

2. The method of item 1, wherein:

the information sharing link is configured to be transmitted to an instant messaging software of the at least one second user and be triggered to display the information sharing interface, wherein the instant messaging software is software installed in a requester terminal of the at least one second user and capable of real-time communication.

3. The method of item 1, wherein:

the information sharing link is in a form of a webpage, a QR code, a bar code, an encoding, a graphic identifier, a program, or a web link.

4. The method of item 1, wherein the information sharing interface is configured to:

display a travel route determined based on the first departure location and the first destination of the at least one first user; or

display the second departure location and the second destination of the at least one second user.

5. The method of item 1, wherein the information sharing interface is configured to guide the at least one second users to input a pick-up sequence.
6. The method of item 1, further comprising:

obtaining and displaying carpooling travel information, wherein the carpooling travel information includes information related to the at least one first user and the at least one second user.

7. The method of item 6, wherein the carpooling travel information includes a carpooling travel route.
8. A carpooling system, comprising:

a first obtaining module configured to obtain a service request and a sharing instruction initiated by at least one first user, wherein the service request includes a first departure location and a first destination; and

a link generation module configured to generate an information sharing link based on the service request and the sharing instruction, wherein the information sharing link is associated with an information sharing interface, and the information sharing interface is configured to guide at least one second user to input a second departure location and a second destination.

9. The system of item 8, further comprising:

a link transmission module configured to transmit the information sharing link to an instant messaging software of the at least one second user so that the information sharing link is triggered to display the information sharing interface, wherein the instant messaging software is software installed in a requester terminal of the at least one second user and capable of real-time communication.

10. The system of item 8, wherein:

the information sharing link is in a form of a webpage, a QR code, a bar code, an encoding, a graphic identifier, a program, or a web link.

11. The system of item 8, wherein the information sharing interface is configured to:

display a travel route determined based on the first departure location and the first destination of the at least one first user; or

display the second departure location and the second destination of the at least one second user.

12. The system of item 8, wherein the information sharing interface is configured to guide the at least one second users to input a pick-up sequence.
13. The system of item 8, further comprising:

an output module configured to obtain and display carpooling travel information, wherein the carpooling travel information includes information related to the at least one first user and the at least one second user.

14. The system of item 13, wherein the carpooling travel information includes a carpooling travel route.
15. A carpooling device, comprising at least one processor and at least storage device, wherein:

the at least one storage device is configured to store instructions; and

the at least on processor is configured to execute the instructions to implement the method of any one of claims 1-7.

16. A computer-readable storage medium, storing computer instructions, wherein the computer instructions are executed to implement the method of any one of claims 1-7.
17. A carpooling method, comprising:

obtaining a service request initiated by at least one first user, the service request including a first departure location and a first destination;

obtaining a second departure location and a second destination of at least one second user inputted via an information sharing interface; and

determining a carpooling travel route based on the first departure location and the first destination of the at least one first user, the second departure location and the second destination of the at least one second user;

wherein the information sharing interface is associated with an information sharing link, and the information sharing link is generated based on the service request and a first instruction of the at least one first user.

18. The method of item 17, wherein:

the method further comprise obtain a pick-up sequence; and

the determining a carpooling travel route based on the first departure location and the first destination of the at least one first user, the second departure location and the second destination of the at least one second user comprises:

determining the carpooling travel route based on the first departure location and the first destination of the at least one first user, the second departure location and the second destination of the at least one second user, and the pick-up sequence.

19. The method of item 17, wherein the determining a carpooling travel route based on the first departure location and the first destination of the at least one first user, the second departure location and the second destination of the at least one second user comprises:

obtaining a carpooling instruction from the at least one first user; and

in response to the second instruction, determining the carpooling travel route based on the first departure location and the first destination of the at least one first user, the second departure location and the second destination of the at least one second user.

20. The method of item 19, further comprising:

generating a first car-hailing order based on the carpooling travel route; and

transmitting the first car-hailing order to a provider terminal of at least one driver.

21. The method of item 17, wherein the determining a carpooling travel route based on the first departure location and the first destination of the at least one first user, the second departure location and the second destination of the at least one second user comprises:

determining an original travel route based on the first departure location and the first destination of the at least one first user;

generating a second car-hailing order based on the original travel route; and

transmitting the second car-hailing order to a provider terminal of at least one driver.

22. The method of item 21, wherein the determining a carpooling travel route based on the first departure location and the first destination of the at least one first user, the second departure location and the second destination of the at least one second user comprises:

updating the original travel route based on the second departure location and the second destination of the at least one second user; and

transmitting the updated travel route to the provider terminal of the at least one driver.

23. A carpooling system, comprising:

a second obtaining module configured to obtain a service request initiated by at least one first user, the service request including a first departure location and a first destination; the second obtaining module also configured to obtain a second departure location and a second destination of at least one second user inputted via an information sharing interface; and

a route determination module configured to determine a carpooling travel route based on the first departure location and the first destination of the at least one first user, the second departure location and the second destination of the at least one second user;

wherein the information sharing interface is associated with an information sharing link, and the information sharing link is generated based on the service request and a first instruction of the at least one first user.

24. The system of item 23, wherein:

the second obtaining module is further configured to obtain a pick-up sequence; and

the route determination module is further configured to determine the carpooling travel route based on the first departure location and the first destination of the at least one first user, the second departure location and the second destination of the at least one second user, and the pick-up sequence.

25. The system of item 23, wherein the route determination module is further configured to:

obtain a carpooling instruction from the at least one first user; and

in response to the second instruction, determine the carpooling travel route based on the first departure location and the first destination of the at least one first user, the second departure location and the second destination of the at least one second user.

26. The system of item 25, further comprising:

an order generation module configured to generate a first car-hailing order based on the carpooling travel route; and

an order transmission module configured to transmit the first car-hailing order to a provider terminal of at least one driver.

27. The system of item 23, further comprising an order generation module and an order transmission module, wherein:

the route determination module is configured to determine an original travel route based on the first departure location and the first destination of the at least one first user;

the order generation module is configured to generate a second car-hailing order based on the original travel route; and

the order transmission module is configured to transmit the second car-hailing order to a provider terminal of at least one driver.

28. The system of item 27, wherein

the route determination module is further configured to update the original travel route based on the second departure location and the second destination of the at least one second user; and

the order transmission module is configured to transmit the updated travel route to the provider terminal of the at least one driver.

29. A carpooling device, comprising at least one processor and at least one storage device; wherein the at least one storage device is configured to store instructions; and the at least on processor is configured to execute the instructions to implement the method of any one of claims 17-22.
30. A computer-readable storage medium, storing computer instructions, wherein the computer instructions are executed to implement the method of any one of claims 17-22.

1. A method for carpooling implemented on a computing device having at least one processor, at least one computer-readable storage medium, and a communication platform connected to a network, comprising:
obtaining a service request and a sharing instruction initiated by a first user, wherein the service request includes a first departure location and a first destination;
generating an information sharing link based on the service request and the sharing instruction; and
transmitting the information sharing link to one or more second users, wherein the information sharing link is associated with an information sharing interface, and the information sharing interface is configured to use the information sharing link and guide at least one of the one or more second users to input a second departure location and a second destination.

2. The method of claim 1, wherein the information sharing link is in a form of a webpage, a QR code, a bar code, an encoding, a graphic identifier, a program, or a web link.

3. The method of claim 1, wherein the information sharing interface is configured to:
display a travel route determined based on the first departure location and the first destination of the first user; or
display the second departure location and the second destination of the at least one second user.

4. The method of claim 1, wherein the information sharing interface is configured to:
guide the at least one of the one or more second users to input a pick-up sequence.

5. The method of claim 1, further comprising:
obtaining and displaying carpooling travel information, wherein the carpooling travel information includes information related to the first user and the at least one second user.

6. The method of claim 5, wherein the carpooling travel information includes a carpooling travel route.

7. A system for carpooling, comprising:
at least one storage device including a set of instructions;
at least one processor in communication with the at least one storage device, wherein when executing the set of instructions, the at least one processor is configured to cause the system to:
obtain a service request and a sharing instruction initiated by a first user, wherein the service request includes a first departure location and a first destination;
generate an information sharing link based on the service request and the sharing instruction; and
transmit the information sharing link to one or more second users, wherein the information sharing link is associated with an information sharing interface, and the information sharing interface is configured to use the information sharing link and guide at least one of the one or more second users to input a second departure location and a second destination.

8. The system of claim 7, wherein the information sharing link is in a form of a webpage, a QR code, a bar code, an encoding, a graphic identifier, a program, or a web link.

9. The system of claim 7, wherein the information sharing interface is configured to:
display a travel route determined based on the first departure location and the first destination of the first user; or
display the second departure location and the second destination of the at least one second user.

10. The system of claim 7, wherein the information sharing interface is configured to:
guide the at least one of the one or more second users to input a pick-up sequence.

11. The system of claim 7, wherein the at least one processor is configured to cause the system to:
obtain and display carpooling travel information, wherein the carpooling travel information includes information related to the first user and the at least one second user.

12. The system of claim 11, wherein the carpooling travel information includes a carpooling travel route.

13-20. (canceled)

21. A system for carpooling, comprising:
at least one storage device including a set of instructions;
at least one processor in communication with the at least one storage device, wherein when executing the set of instructions, the at least one processor is configured to cause the system to:
obtain a service request initiated by a first user, the service request including a first departure location and a first destination of the first user;
obtain a second departure location and a second destination of at least one second user inputted via an information sharing interface; and
determine a carpooling travel route based on the first departure location and the first destination of the first user, the second departure location and the second destination of the at least one second user;
wherein the information sharing interface is associated with an information sharing link, and the information sharing link is generated based on the service request and a first instruction of the first user and transmitted to the at least one second user.

22. The system of claim 21, wherein to determine a carpooling travel route, the at least one processor is configured to cause the system to:
obtain a pick-up sequence; and
determine the carpooling travel route based on the first departure location and the first destination of the first user, the second departure location and the second destination of the at least one second user, and the pick-up sequence.

23. The system of claim 21, wherein to determine a carpooling travel route, the at least one processor is configured to cause the system to:
obtain a second instruction from the first user; and
in response to the second instruction, determine the carpooling travel route based on the first departure location and the first destination of the first user, the second departure location and the second destination of the at least one second user.

24. The system of claim 21, wherein the at least one processor is further configured to cause the system to:
generate a first car-hailing order based on the carpooling travel route; and
transmit the first car-hailing order to at least one driver.

25. The system of claim 21, wherein the at least one processor is further configured to cause the system to:
determine an original travel route based on the first departure location and the first destination;
generate a second car-hailing order based on the original travel route; and
transmit the second car-hailing order to at least one driver.

26. The system of claim 25, wherein the at least one processor is further configured to cause the system to:
update the original travel route based on the second departure location and the second destination of the at least one second user; and
transmit the updated travel route to the at least one driver.

27-28. (canceled)

29. The system of claim 25, wherein the at least one driver is determined based on information inputted by the first driver and the original travel route.

30. The system of claim 29, wherein the information inputted by the first driver includes at least one of a departure time, a vehicle type, or a service type.
